(19) United States
(12) Patent Application Publication
(10) Pub. No.: US 2014/0184085 A1
(43) Pub. Date: Jul. 3, 2014

(54) ELECTRONIC DEVICE AND CONTROL METHOD THEREOF

(71) Applicant: Kabushiki Kaisha Toshiba, Tokyo (JP)

(72) Inventor: Akira Yoshida, Konosu-shi (JP)

(73) Assignee: Kabushiki Kaisha Toshiba, Tokyo (JP)

(21) Appl. No.: 14/017,222

(22) Filed: Sep. 3, 2013

Related U.S. Application Data
(63) Continuation of application No. PCT/JP2013/058520, filed on Mar. 25, 2013.

(30) Foreign Application Priority Data
Dec. 27, 2012 (JP) 2012-285121

(51) Int. Cl. H05B 33/08

(52) U.S. Cl. CPC H05B 33/089
USPC 315/185 R

(57) ABSTRACT

According to one embodiment, an electronic device includes, a light source, LED protective elements, a detecting module, a determining module, and a setting module. The light source includes LED elements connected in series. The power supplying module configured to supply a drive voltage to the light source. The LED protective elements connected to the respective LED elements in parallel. The detecting module configured to detect a fluctuation in the drive voltage supplied to the light source and the LED protective elements. The determining module configured to determine that the fluctuation in the drive voltage detected by the detecting module has an abnormal value.

### CROSS REFERENCE TO RELATED APPLICATIONS

This application is a Continuation Application of PCT Application No. PCT/JP2013/058520, filed Mar. 25, 2013 and based upon and claiming the benefit of priority from Japanese Patent Application No. 2012-285121, filed Dec. 27, 2012, the entire contents of all of which are incorporated herein by reference.

### FIELD

Embodiments described herein relate generally to an electronic device having a display device and a control method thereof.

### BACKGROUND

In an electronic device such as a television broadcast receiver or a personal computer having a display device, there are some display systems for the display device that use illumination light.

When an illumination device that provides illumination light is a light emitting device (LED), a protection circuit that monitors a change in terminal voltage of an LED element and operates when the terminal voltage exceeds a threshold value. However, the protection circuit may erroneously operate due to an increase in temperature of the LED element or a variation (a case error) in LED elements in some cases.

Nowadays, since an amount of luminescence per LED element has been increased, the number of LED elements can be reduced, namely, a component cost can be decreased.

However, when an amount of luminescence per element increases, an LED (drive) current must be raised, and overheating, damage to the protection circuit, smoke generation, or firing may possibly occur if the protection circuit erroneously operates.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of an electronic device according to an embodiment;

FIG. 2 shows an example of an illumination device drive circuit of the electronic device according to an embodiment;

FIG. 3 shows an example of the illumination device drive circuit of the electronic device according to an embodiment;

FIG. 4A shows an example of an operation of the illumination device drive circuit of the electronic device according to an embodiment;

FIG. 4B shows an example of an operation of the illumination device drive circuit of the electronic device according to an embodiment;

FIG. 5 shows an example of an operation of the illumination device drive circuit of the electronic device according to an embodiment;

FIG. 6 shows an example of an operation of the illumination device drive circuit of the electronic device according to an embodiment;

FIG. 7 shows an example of an operation of the illumination device drive circuit of the electronic device according to an embodiment; and

FIG. 8 shows an example of the illumination device drive circuit of the electronic device according to an embodiment.

### DETAILED DESCRIPTION

Various embodiments will be described hereinafter with reference to the accompanying drawings.

In general, according to one embodiment, an electronic device comprises: a light source, LED protective elements, a detecting module, a determining module, and a setting module. The light source comprising LED elements connected in series. The power supplying module configured to supply a drive voltage to the light source. The LED protective elements connected to the respective LED elements in parallel. The detecting module configured to detect a fluctuation in the drive voltage supplied to the light source and the LED protective elements. The determining module configured to determine that the fluctuation in the drive voltage detected by the detecting module has an abnormal value.

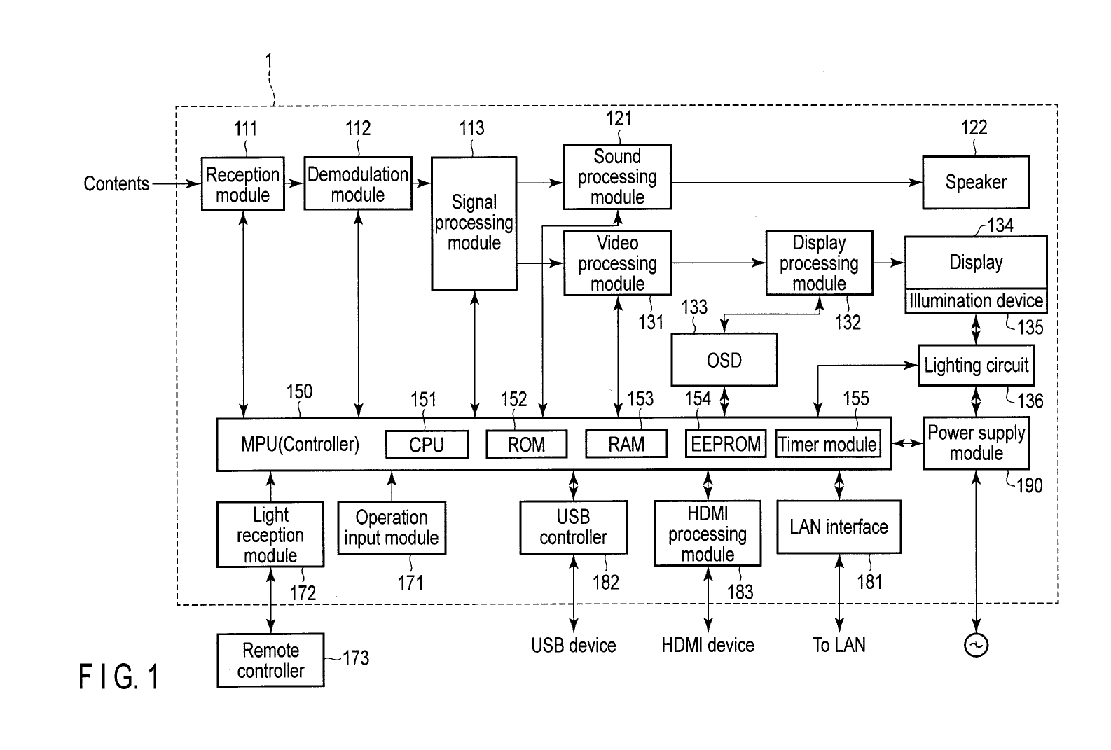

FIG. 1 shows an example of an electronic device, e.g., a television broadcast receiver. It is to be noted that the television broadcast receiver (which will be referred to as a television device hereinafter) will be described hereinafter as an example of the electronic device, but portability (mobility), a size, and others of, e.g., a personal computer (PC), a tablet device, or a mobile phone set are arbitrary as long as it is an apparatus that has a display device and uses illumination light as a display system in the display unit. Further, elements or structures described below may be realized in the form of software or hardware by using a microcomputer (a processor, a central processing unit (CPU)). Furthermore, a method of acquiring or outputting contents displayed by the display device is arbitrary, and there are, e.g., use of space waves (electric waves), use of a network such as a cable (including an optical fiber) or an Internet protocol (IP) communication network, or use of a recording medium such as a semiconductor memory. It is to be noted that contents may be referred to as a stream, a program, or information, and video, sound, or music is included. Moreover, the video includes a moving picture, a still picture, or text (information represented by, e.g., characters or symbols shown in a coded sign string), and an arbitrary combination of these members.

In FIG. 1, a television device 101 comprises a reception module 111, a demodulation module 112, a signal processing module 113, a sound processing module 121, a video processing module 131, a display processing module 132, a controller (a main processing unit, MPU) 150, a power supply module 190, and others. Additionally, the television device 101 comprises a speaker (a sound reproducer) 122 and a display (a picture display unit) 134. The MPU 150 is connected with an operation input module 171, a light reception module 172, an LAN interface 181, a USB controller 182, an HDMI processing module 183, and others.

The light reception module 111 receives broadcast signals (a program) provided by a broadcasting organization (a broadcasting station) as a broadcast (space waves) and selects a channel (selects a program). It is to be noted that the reception module 111 can also receive contents (a stream/a program) provided by a distribution operator (a contents provider) through a cable or a wireless system. The reception module 111 inputs broadcast signals or contents subjected to channel selection or program selection to the demodulation module 112.

The demodulation module 112 demodulates the broadcast signals or the contents from the reception module 111. The demodulation module 112 inputs the demodulated program or contents to the signal processing module 113.

The signal processing module 113 comprises, e.g., a digital signal processor (DSP) and separates the program or the contents (digital signals) demodulated by the demodulation module 112 into a video signal, a sound signal, and a data signal other than the video signal and the sound signal (text information (an electric program guide), licensing information (CAS information), and DRM (a content protection system) information, and others).

The signal processing module 113 supplies the separated sound signal to the sound processing module 121 and the video signal to the video processing module 131, respectively. The signal processing module 113 also supplies the data signal to the controller 150.

The sound processing module 121 convers the sound signal from the signal processing module 113 into an audio signal that is in a format which can be reproduced by the speaker 122 and supplies the converted signal to the speaker 122. The speaker 122 reproduces sound and/or audio from the supplied audio signal.

The video processing module 131 converts (executes display processing to) the video signal from the signal processing module 113 into a display signal that is in a format which can be reproduced (displayed) by the display 134 and outputs the converted signal to the display processing module 132.

The OSD processing module 133 generates an on-screen display (OSD) signal, which is used for superimposing and displaying graphical user interface (GUI) display, subtitle display, time display, and others on the display signal from the video processing module 131 based on the data signal supplied from the signal processing module 113 and/or a control signal supplied from the controller 150.

The display processing module 132 executes image quality adjustment processing with respect to an image per frame at the time of displaying a video signal from the video processing module 131 as display video (image display) in such a manner that, e.g., a color tone, brightness, sharpness, or contrast can meet predetermined conditions in the condition range that enables reproduction (display) by the display 134. It is to be noted that control information (a variable controlled by input of a numerical value or a variable controlled by input of a visible instruction using display video provided by the CUI) for the image quality adjustment processing is input as input of an instruction from an operation input module 171 or a remote controller 173 which will be described later or a control instruction based on an application (software) held in a portable terminal device (which will be referred to as a mobile terminal hereinafter).

The display processing module 132 also superimposes a display signal from the video processing module 131 after the image quality adjustment processing and an OSD signal from the OSD processing module 133 and supplies the superimposed signal to the display 134.

The display 134 comprises a liquid display panel including pixels aligned in, e.g., a matrix form and an illumination device 135 integrally attached to the liquid crystal display panel. The display 134 displays video associated with a display signal from the display processing module 132 as contract and a color of selectively transmitted light in illumination light (backlight) output from the illumination device 135 for an image displayed in the liquid display panel. The illumination device 135 comprises light emitting devices (LEDs) and outputs light (illumination light) having predetermined brightness and color associated with a drive voltage from a lighting circuit (an LED driver) 136.

It is to be noted that the television device 101 may have a configuration comprising a video output terminal in place of or in parallel with the display 134. Further, the television device 101 may have a configuration comprising a sound output terminal in place of the speaker 12.

The controller (a main processing unit (MPU)) 150 controls operations of various elements in the television device 101. The controller 150 comprises a central processing unit (CPU) 151, a read-only memory (ROM) 152, a rewritable (random access) memory (RAM) 153, a nonvolatile memory (EEPROM) 154, a timer module (a reservation management unit) 155, and others. The controller 150 executes various kinds of processing in accordance with input of an instruction (a user operation) from the operation input module 171 or the remote controller 173 through the light reception module 172.

The CPU 151 includes an operation element or firmware that executes various kinds of operation processing, a memory region, and others. The CPU 151 realizes various kinds of functions (processing) by executing a program held in the ROM 152 or the EEPROM 154.

The ROM 152 holds a program that controls the television device 101, e.g., a program that realizes various functions such as copy and move (move, no more copy, reproduction prohibited) of contents (a program).

The CPU 151 activates the program held in the ROM 152 in accordance with input of an instruction from the operation input module 171 or the remote controller 173 or a control instruction according to an application held in a mobile terminal or the like. As a result, the controller 150 controls an operation of each unit.

The RAM 153 functions as a work memory (a work area) of the CPU 151 and stores a result of an operation performed by the CPU 151, data read by the CPU 151, input of an instruction from the operation input module 171 or the remote controller 173, a control instruction according to the application in the mobile terminal or the like, i.e., a control command, and others.

The EEPROM 154 stores various kinds of setting information, programs, and others.

The operation input module 171 inputs an operation signal associated with a user operation (input of an instruction) to the controller 150, and it is, e.g., an operation key (an operation panel). The operation input module 171 may be, e.g., a keyboard, a mouse, a touch pad, or an input device in an arbitrary format that generates an operation signal in association with an operation. It is to be noted that, when the display 134 is integral with the television device 101 and has a touch panel function, the operation input module 171 may be a touch panel that is integrally formed with the display 134.

The remote controller 173 generates an operation signal that can be identified by the light reception module 171 and is associated with a user operation from input of an operation performed by a user. The remote controller 173 transmits the generated operation signal to the light reception module 172 by, e.g., communication using infrared light.

The light reception module 172 receives the operation signal from the remote controller 173 and supplies, e.g., an instruction signal to the CPU 151 as an instruction for the CPU 51 associated with the operation signal. The CPU 151 controls an operation of each unit associated with a user operation performed by the remote controller 173 or realizes a function in accordance with the instruction signal from the light reception module 172.

It is to be noted that the instruction signal supplied from the remote controller 173 to the light reception module 172 may be realized by, e.g., wireless communication using electric waves which have a predetermined frequency and output.

The LAN interface 181 enables any other television device, a recorder device, or an external tuner on a home network (digital living network alliance (DLNA) (a registered trademark)) to share contents. Furthermore, the LAN interface 181 can be connected to the Internet through a public communication line and controls, e.g., download of contents provided by an arbitrary server on the Internet or a provider.

When a USB device (an external device) connected through an interface based on the universal serial bus (USB) standard, e.g., a USB-HDD (a network attached storage, NAS), or an extended reader/writer that enables transmission or reception of data with respect to a memory card is connected, the USB controller 182 transmits or receives data, namely, reads or writes data with respect to the USB device which is a connection destination. It is to be noted that, when a device connected through the USB-HDD or the extended reader/writer can hold contents, a predetermined DRM (a content protection system) can be applied to the contents held in the connection destination.

The HDMI processing module 183 is an HDMI interface that performs bidirectional communication based on HDMI (a registered trademark), i.e., the high definition multimedia interface (HDMI) standard. The HDMI processing module 183 is connected with a blu-ray (a registered trademark) recorder, a DVD recorder, a hard disk recorder, or a device based on the HDMI standard (an HDMI device). The HDMI processing module 183 can transmit or receive contents (a stream) with respect to a connected HDMI device.

The controller (MPU) 150 includes the timer module.

The timer module 155 can manage information such as a time, a reservation time (a date and time) for programmed recording that is set by input from a user, and a recording target channel and hold this information. The timer module 155 constantly acquires “time information” which is called a time offset table (TOT) included in a digital broadcast signal received by the reception module 111. Moreover, the timer module 155 also functions as, e.g., a clocking unit for a scheduler functions or a messenger function supplied from a mobile terminal device.

The timer module 155 also controls ON/OFF (energization) of a power supply relative to commercial power effected by the power supply module 190 at the time of execution of programmed recording subjected to recording reservation or at a predetermined time set by the scheduler function or the messenger function.

The power supply module 190 converts an alternating-current (AC) voltage which is the commercial power into a direct current (DC) and outputs a DC 31 V, a DC 5 V used for an operation of the lighting circuit 136 or the like, power (a terminal voltage) for the LED element, or a DC 24 V used for an operation of each of various elements as secondary power used for, e.g., an operation of the controller (MPU) 150.

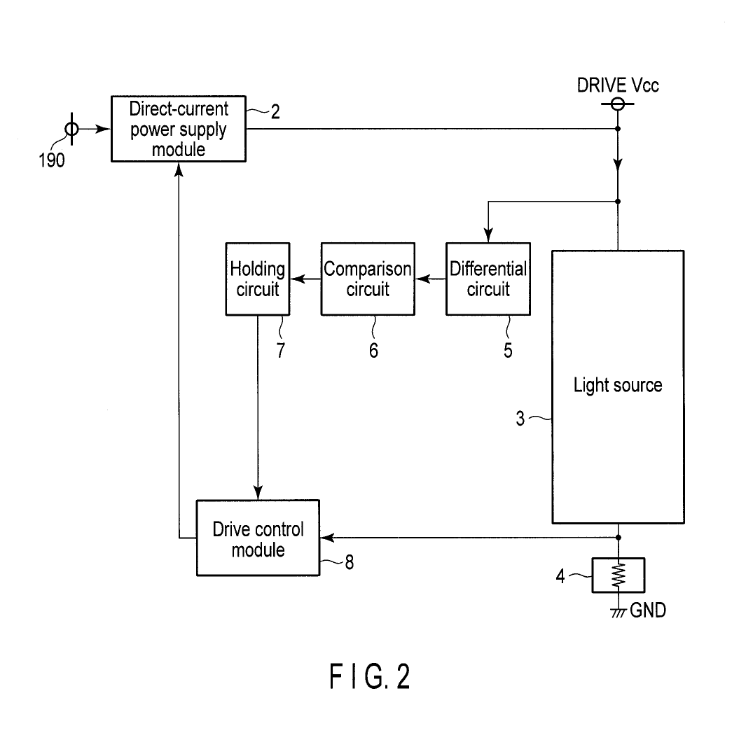

FIG. 2 shows an example of the lighting circuit (an LED driver) that operates the LED element in the illumination device.

The lighting circuit (the LED driver) 136 comprises at least a direct-current power supply module (a DC-DC converter) 2, a power supply detector (a current detection resistor) 4, an abnormal voltage detector (a differential circuit) 5, an abnormality determiner (a comparison circuit) 6, a holding circuit (a reset unit) 7, a drive control module 8, and others.

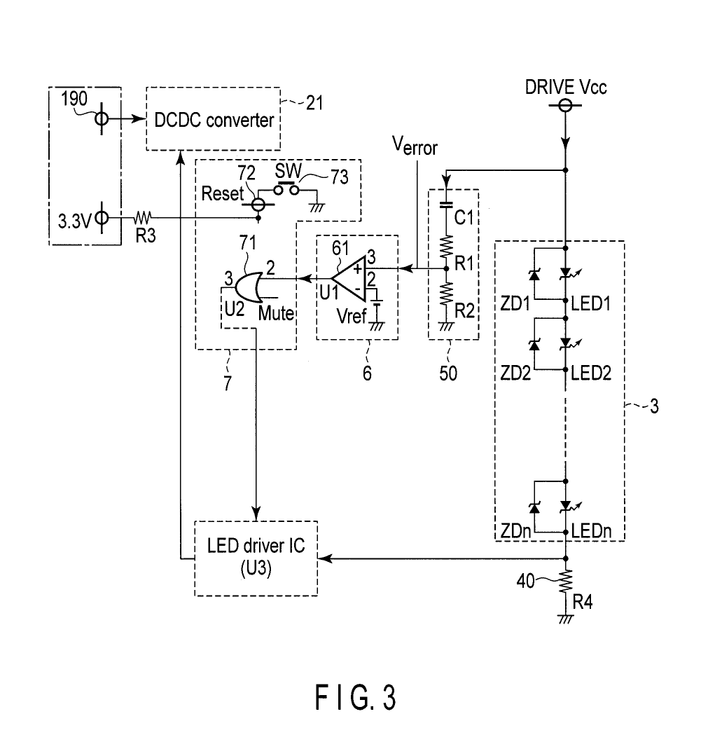

Although an example of the direct-current power supply module 2 is shown in FIG. 3, it comprises, e.g., a DC-DC converter 21 and converts a DC input from the power supply module 190 into a predetermined voltage that is used as a terminal voltage of an LED bar 3 which is a light source for the illumination device 135. It is to be noted that, when the DC-DC converter 21 adopts a pulse width modulation (PWM) system, controlling a duty of an ON time (a ratio of the ON time per pulse) enables changing an effective output, i.e., brightness at the time of light emission.

Although an example of the light source 3 is shown in FIG. 3, it is a unit which is called an LED bar and has an arbitrary number (n, n is a positive integer) LED-1, LED-2, . . . , LED-n connected in series with respect to an applied voltage between an anode and a cathode. It is to be noted that zener diodes ZD-1, ZD-2, ZD-n (n is a positive integer) used for electrostatic discharge (ESD) protection are connected to the respective LEDs (elements) in parallel.

The power supply detector 4 is a load resistor (R4) 40 configured to detect that a predetermined voltage is applied to the LED bar 3 (presence/absence of voltage supply), and it is placed on a cathode side of the LED bar 3. It is to be noted that the electric power can be detected based on presence/absence of voltages applied to both ends of the load resistance (R4) 40.

The abnormal voltage detector 5 detects changes in an arbitrary number of LED voltages V_{LED} in the LED bar 3 based on, e.g., disconnection of bonding (a wire) of the LED bar 3, and it is formed of, e.g., a differential circuit (CR circuit) 50 comprising a DC cut element (a capacitor (C1)) and voltage dividers (partial resistors (R1, R2)). It is to be noted an output voltage DRIVE_{Vcc} of DRIVER applied to the LED bar 3 is input to the C1 side of the differential circuit 50.

As shown in FIG. 3 representing an example of the abnormality determiner 6, the abnormality determiner 6 is formed of a comparison circuit (a comparator U1) 61 that determines whether intensity of an LED voltage V_{LED} detected by the abnormality voltage detector 5 has a normal value or an abnormal value (occurrence of LED open) by comparing the LED voltage V_{LED} and a reference voltage V_{ref}. It is to be noted that the abnormality determiner 6 inputs a signal of a connection point of R1 and R2 of the differential circuit 5 (the abnormal voltage detector 5) to one end of the comparator U1 (61). This input signal is compared with the reference voltage V_{ref} at the other end of the comparator U1 (61).

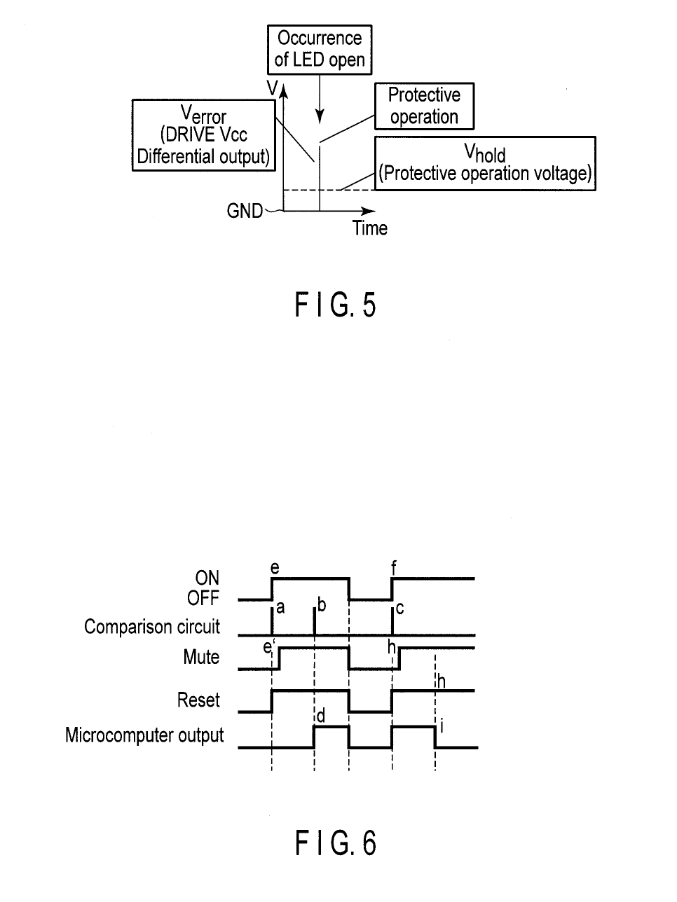

As depicted in FIG. 3 showing an example of the holding circuit 7, the holding circuit 7 is formed of a microcomputer (a comparator U2) which holds detection of an abnormality in the LED bar 3 effected by the abnormality determiner 6 and a reset circuit 72 connected to the microcomputer (the comparator U2) 71. The microcomputer 71 holds an abnormality detection signal Error output from the abnormality determiner 6 on the upstream side until a reset signal Reset is input thereto from a switch 73 of the reset circuit 72. It is to be noted that the reset circuit 72 uses, e.g., an output of DC 3.3 V from the power supply module 190 as operation electric power. Further, one of inputs to the microcomputer (the comparator U2) 71 is a mute signal, and it prevents the abnormal voltage detector 5 (the differential circuit 50) from erroneously detecting an abnormality of the LED bar 3 at the time of, e.g., turning on the power supply (activation). That is, when an output from the comparator U1 (61) of the abnormality determiner 6 is monitored by the microcomputer (a comparator) U2 71 and an abnormal state is once detected, a protective function is continuously carried out, and a protective state is held even if the power supply is turned off/on. It is to be noted that a mute end (an input 1) of the microcomputer U2 (71) prevents the microcomputer U2 (a protection circuit) from being triggered at rising edges “e”, “f”, and the like when the power supply is ON as shown in FIG. 6, and it delays detection timing as “e′” and “f′”. Further, as described above, when a protective operation voltage is detected and the protective function is carried out, the reset circuit 72 can be operated from the SW 73 at the time of eliminating a defective state of the LED element (the LED bar) by repairing or the like. As a result, the operation of the circuit (the light source 3) can be stored to a normal state.

Although an example of the drive control module 8 is shown in FIG. 3, the drive control module 8 sets a voltage applied to the LED bar 3 (outputs an instruction value relative to the direct-current power supply module 2), and it is formed of, e.g., a microcomputer U3 (a driver IC) 81. The microcomputer U3 (the driver IC) 81 outputs a control signal associated with a normal operation (lighting) or a protective operation (non-lighting) to the DC-DC converter 21 (the direct-current power supply module 2). That is, an output from the comparator U1 (61) of the abnormality determiner 6 is input to the LED driver IC (the microcomputer U3) 81 through the microcomputer U2 (71) of the holding circuit 7, and the normal operation (lighting control) or the protective operation (non-lighting) is carried out in accordance with a decision of the microcomputer U2. It is to be noted that, when the DC-DC converter 21 adopts the PWM system, an effective output is limited at a predetermined ratio at the time of the protective operation by controlling a duty of the ON time, and complete extinction (non-lighting) is avoided, and illumination light having fixed brightness can be obtained.

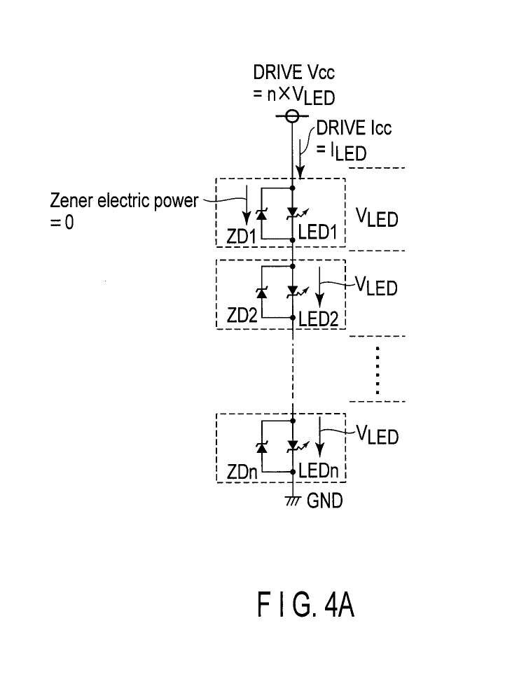

In detail, although each of FIG. 4A and FIG. 4B shows an example, in the light source having the LED elements connected in series, when LED′ (FIG. 4B) of any LED element is open (a lighting failure) due to, e.g., disconnection of bonding, i.e., when the light source 3 fails to operate, an applied voltage that should be essentially applied to LED₁ is applied to the zener diode ZE₁ (FIG. 4B) interposed in parallel with the open LED. As a result, the drive voltage (a driving voltage) DRIVE_{Vcc} that is applied to the open LED₁ increases to a zener voltage V_{Z} (FIG. 4B) applied to both ends of the zener diode ZD₁ from V_{LED} (FIG. 4A) in the normal state.

That is, the drive voltage (the driving voltage) DRIVE_{Vcc} at both the ends of the LED bar 3 is presented as follows in the normal state (FIG. 4A):

DRIVE_{Vcc}=n×V_{LED}.

However, in the open state (FIG. 4B), this voltage can be represented as follows:

DRIVE_{Vcc}=(n−1)×V_{LED}×V_{Z}.

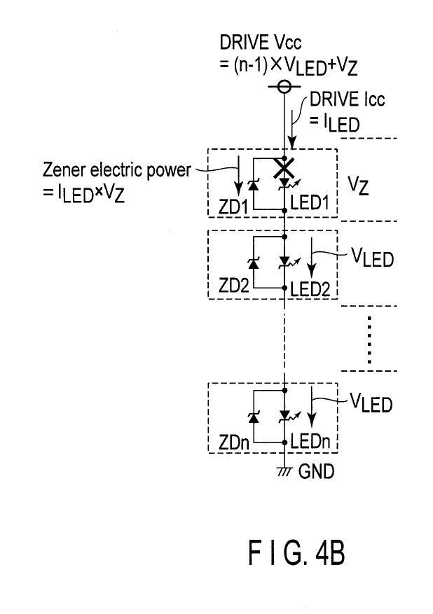

At this time, in the abnormal voltage detector 5 (FIG. 2), i.e., the differential circuit (the CR circuit 50) shown in FIG. 3, such a spike-shaped waveform change (an instantaneous voltage fluctuation Vₑᵣᵣₒᵣ) as shown in FIG. 5 can be detected in the LED drive voltage DRIVE_{Vcc}.

Here, in regard to the zener diode voltage V_{Z} and the LED voltage V_{LED}, a protective operation voltage V_{hold} used for detecting the voltage fluctuation Vₑᵣᵣₒᵣ can be set to be less than the following expression:

V_{hold}=V_{Z}−V_{LED}.

That is, as the zener voltage V_{Z} of the protective zener diode, a voltage in the range of 6 to 12 V is often used, and the LED voltage V_{LED} is approximately 3.3 V±1 V even though a temperature change (temperature drift) or a variation (a case error) in the LED elements is taken into consideration. Therefore, when the protective operation voltage (a protective operation voltage) V_{hold} is set to approximately 1 V in advance, open defects of the LED elements can be all detected.

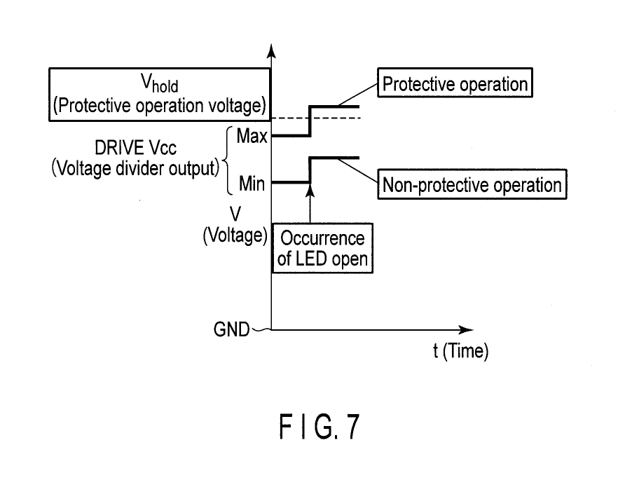

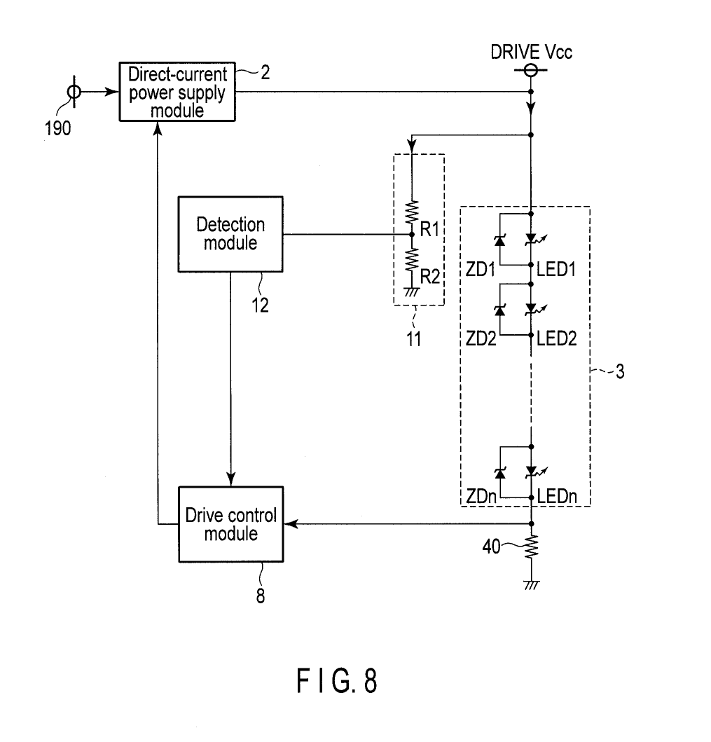

It is to be noted that, when the abnormal voltage detector described in conjunction with FIG. 2 is such a simple voltage divider 11 alone as shown in FIG. 8 that is often observed in a standard circuit, the LED drive voltage DRIVE_{Vccd} is a divided output Vcc_{d} obtained by dividing the LED drive voltage DRIVE_{Vcc} as shown in FIG. 7.

That is, although the divided output Vcc_{d} at the time of occurrence of an abnormality is compared with the protective operation voltage (the protective operation voltage) V_{hold} in the detection module 12, the LED element whose divided output vcc_{d} at the time of occurrence of an abnormality is Vₘₐₓ higher than the protective operation voltage V_{hold} contributes to detection of an abnormality (normal detection of an abnormality is possible). However, the LED elements are different from each other due to a temperature change (temperature drift) or a variation (a case error) of the LED elements. Therefore, the divided output vcc_{d} may not enable detection of an abnormality even though the abnormality has occurred in each LED element that outputs Vccₘᵢₙ that is lower than V_{hold} which is set to a voltage with a margin so that an erroneous operation is not performed in the normal state (erroneous detection is not performed in the normal state).

Moreover, in today's LED liquid crystal television device, although the number of the LED elements is reduced and a cost is decreased, a current of several hundred 100 mA flows through each zener diode, and its power consumption is high. Therefore, overheating occurs and defects such as smoke generation or firing arise in some cases, the zener diode may fail to operate in the worst case, and the light source may extinct if a failure occurs in the open state.

Therefore, the present suggestion is useful since it determines whether the LED voltage V_{LED} detected by the abnormal voltage detector 5 (the differential circuit 50) including the DC cut element (a C component) has a normal value or an abnormal value (occurrence of the LED open) by comparing the LED voltage V_{LED} with the reference voltage V_{ref}.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a light source comprising LED elements connected in series;
a power supplying module configured to supply a drive voltage to the light source;
LED protective elements connected to the respective LED elements in parallel;
a detecting module configured to detect a fluctuation in the drive voltage supplied to the light source and the LED protective elements;
a determining module configured to determine that the fluctuation in the drive voltage detected by the detecting module has an abnormal value; and
a setting module configured to set the drive voltage supplied to the light source by the power supplying module to a protective operation voltage different from a voltage in a normal state when the determining module has determined the abnormal value.

2. The electronic device of claim 1, further comprising;
holding module configured to hold the abnormal value determination until a reset instruction is issued when the determining module has determined the abnormal value.

3. The electronic device of claim 1, wherein the detecting module comprises a differential circuit which detects a non-DC component from a voltage applied to each LED protective element in the fluctuation of the drive voltage.

4. The electronic device of claim 3, further comprising;
erroneous detection preventing module configured to stop detection of a fluctuation in the drive voltage by the detecting module for a fixed period.

5. The electronic device of claim 1, further comprising:
displaying module configured to display an image by using light output from the light source.

6. The electronic device of claim 5, further comprising:
image processing module configured to process an image signal associated with the image displayed by the displaying module.

7. A control method of an electronic device, comprising:
detecting a change in a drive voltage applied to a light source which comprises LED elements connected in series and protective elements connected to the respective LED elements in parallel; and
setting the drive voltage to a protective operation voltage when the detected change in the drive voltage has an abnormal value.
